(19) United States
(12) Patent Application Publication
(10) Pub. No.: US 2026/0189758 A1
(43) Pub. Date: Jul. 2, 2026

(54) VIDEO DOWNLOADING METHOD AND APPARATUS, DEVICE, MEDIUM, AND PROGRAM PRODUCT

(71) Applicant: Beijing Zitiao Network Technology Co., Ltd., Beijing (CN)

(72) Inventor: Zhiwei FAN, Beijing (CN)

(21) Appl. No.: 19/421,777

(22) Filed: Dec. 16, 2025

(30) Foreign Application Priority Data
Dec. 26, 2024 (CN) 202411945403.3

(51) Int. Cl. H04N 21/466; H04N 21/438

(52) U.S. Cl. CPC H04N 21/466; H04N 21/438

(57) ABSTRACT

The present disclosure provides a video downloading method and apparatus, a device, a medium, and a program product. The method includes: obtaining current playing state information of a current video to be downloaded before downloading; determining download length information corresponding to the current video to be downloaded according to the current playing state information and a prediction model; the prediction model is obtained by reinforcement learning based on a heuristic determining method and sample playing state information corresponding to a sample video to be downloaded, and the heuristic determining method is a method for determining length information that needs to be downloaded for the sample video to be downloaded by using a heuristic method; and downloading the current video to be downloaded according to the download length information corresponding to the current video to be downloaded.

The present application claims priority to Chinese Patent Application No. 2024119454033, filed on Dec. 26, 2024, which is incorporated herein by reference in its entirety as a part of the present application.

### TECHNICAL FIELD

An embodiment of the present disclosure relates to computer technology, and in particular to a video downloading method and apparatus, a device, a medium, and a program product.

### BACKGROUND

With the rapid development of computer technology, it is usually needed to download the video to be played in advance to ensure the video playing fluency. However, the longer the downloaded video, the higher the video fluency, but the higher the network bandwidth needs to be consumed, which increases the bandwidth cost. Therefore, it is needed to determine appropriate download length information to improve the video playing fluency and reduce the bandwidth cost.

### SUMMARY

The present disclosure provides a video downloading method and apparatus, a device, a medium, and a program product, so as to accurately determine proper download length information, so as to improve the video playing fluency while reducing the bandwidth costs.

At a first aspect, an embodiment of the present disclosure provides a video downloading method, including:
obtaining current playing state information of a current video to be downloaded before downloading;
determining target download length information corresponding to the current video to be downloaded according to the current playing state information and a target prediction model; wherein the target prediction model is obtained by reinforcement learning based on a heuristic determining method and sample playing state information corresponding to a sample video to be downloaded, and the heuristic determining method is a method for determining length information that needs to be downloaded for the sample video to be downloaded by using a heuristic method; and
downloading the current video to be downloaded according to the target download length information corresponding to the current video to be downloaded.

At a second aspect, an embodiment of the present disclosure further provides a video downloading apparatus, comprising:
a current playing state information acquisition module, which is configured to obtain current playing state information of a current video to be downloaded before downloading;
a target download length information determining module, which is configured to determine target download length information corresponding to the current video to be downloaded according to the current playing state information and a target prediction model; wherein the target prediction model is obtained by reinforcement learning based on a heuristic determining method and sample playing state information corresponding to a sample video to be downloaded, and the heuristic determining method is to determine length information that needs to be downloaded for the sample video to be downloaded based on a present heuristic processing method; and
a video download module, which is configured to download the current video to be downloaded according to the target download length information corresponding to the current video to be downloaded.

At a third aspect, an embodiment of the present disclosure provides an electronic device, which includes:
one or more processors; and
a storage apparatus, which is configured to store one or more programs,
the one or more programs, when executed by the one or more processors, cause the one or more processors to implement the video downloading method according to any one of the embodiments of the present disclosure.

At a fourth aspect, an embodiment of the present disclosure provides an storage medium containing computer-executable instructions, the computer-executable instructions, when executed by a computer processor, are configured to execute the video downloading method according to any one of the embodiments of the present disclosure.

At a fifth aspect, an embodiment of the present disclosure provides a computer program product, comprising a computer program, wherein the computer program, when executed by a processor, implements the video downloading method according to any one of the embodiments of the present disclosure.

### BRIEF DESCRIPTION OF DRAWINGS

With reference to the accompanying drawings and the following detailed description, the above-mentioned and other features, advantages, and aspects of the embodiments of the present disclosure will become more apparent. Throughout the drawings, identical or similar reference numerals denote identical or analogous elements. It should be understood that the drawings are schematic, and the components and elements are not necessarily drawn to scale.

FIG. 1 is a flowchart of a video downloading method according to an embodiment of the present disclosure;

FIG. 2 is a flowchart of another video downloading method according to an embodiment of the present disclosure;

FIG. 3 is a flowchart of still another video downloading method according to an embodiment of the present disclosure;

FIG. 4 is a schematic structural diagram of a video downloading apparatus according to an embodiment of the present disclosure; and

FIG. 5 is a schematic structural diagram of an electronic device according to an embodiment of the present disclosure.

### DETAILED DESCRIPTION

The embodiments of the present disclosure will be described below in greater detail with reference to the accompanying drawings. Although certain embodiments are shown in the drawings, it should be understood that the disclosure may be implemented in various forms and should not be construed as being limited to the embodiments set forth herein. On the contrary, these embodiments are provided so that the disclosure will be thorough and complete. It should also be understood that the drawings and embodiments are provided solely for illustrative purposes and do not limit the scope of protection sought for the disclosure.

It should be understood that the steps recited in the method embodiments of the disclosure may be performed in a different order and/or in parallel. Moreover, the method embodiments may include additional steps and/or omit some of the illustrated steps. The scope of the disclosure is not limited in this regard.

As used herein, the term “including” (and its variants) is open-ended, which refers to “including but not limited to”. The term “based on” refers to “based at least in part on”. The phrase “an embodiment” refers to “at least one embodiment”; the phrase “another embodiment” refers to “at least one further embodiment”; and the phrase “some embodiments” refers to “at least some embodiments”. Definitions of other terms will be provided in the descriptions below.

It is to be noted that, in the present disclosure, terms such as “first,” “second,” and the like are used merely to distinguish among different devices, modules, or units, and are not intended to prescribe any order or interdependency of the functions performed by these devices, modules, or units.

Also note that modifiers such as “a,” “an,” and “a plurality of” are illustrative rather than limiting. Those skilled in the art should understand that, unless the context clearly indicates otherwise, the terms should be construed as “one or more.”

The names of messages or information exchanged between multiple devices in the embodiments of the disclosure are provided for illustrative purposes only and are not intended to limit the scope of such messages or information.

It should be understood that, before applying any technical solution disclosed in the embodiments, the types of personal information involved, the scope of use, and the usage scenarios must be communicated to users through appropriate means in accordance with applicable laws and regulations, and the users'consent must be obtained.

For example, upon receiving an active request from a user, a prompt may be sent to the user to explicitly indicate that the requested operation will require accessing and using the user's personal information, thereby allowing the user to decide, based on the prompt, whether to provide personal information to the software or hardware (such as an electronic device, application, server, or storage medium) that will carry out the technical solution.

As an optional but non-limiting implementation, the prompt may be displayed in a pop-up window containing explanatory text. The pop-up window may also include controls allowing the user to choose “Agree” or “Disagree” to provide personal information to the electronic device.

It should be understood that the notification and consent process described above is merely illustrative and does not limit the implementation of the disclosure; any other method that complies with applicable laws and regulations may also be used.

It should also be understood that all data involved in the technical solution (including but not limited to the data itself as well as its acquisition or use) must comply with the relevant laws, regulations, and requirements.

FIG. 1 is a flowchart of a video downloading method according to an embodiment of the present disclosure. The embodiment of the present disclosure is suitable for determining the appropriate download length information of a video to be downloaded, so as to download a video with an appropriate length. The method can be implemented by a video downloading apparatus, which can be implemented in the form of software and/or hardware, or alternatively, by an electronic device. The electronic device can be a mobile terminal, a PC terminal or a server.

As shown in FIG. 1, the video downloading method specifically includes the following steps.

S110: obtaining current playing state information of a current video to be downloaded before downloading.

The current video to be downloaded refers to the video that needs to be downloaded at the current time. The current playing state information may refer to the video playing state information before the client downloads the current video to be downloaded. The current playing state information is used to characterize the information about the environment state where the client is located before downloading the current video to be downloaded. For example, the current playing state information may include, but is not limited to, at least one selected from the group consisting of:
a currently-predicted playing duration, a currently-predicted bandwidth, position information of the current video to be downloaded in a video sequence to be downloaded, and a bit rate and buffer length information corresponding to each video to be downloaded in the video sequence to be downloaded.

The currently-predicted playing duration can be the predicted time length from the current time to the time when the client quits playing. The currently-predicted playing duration is used to characterize the subsequent video viewing duration, that is, how long the client will quit video playing. The currently-predicted bandwidth may be the currently-predicted network bandwidth of the subsequently download video. The video sequence to be downloaded includes a plurality of videos to be downloaded by the client. The current video to be downloaded refers to a video to be downloaded that needs to be downloaded at the current time in the video sequence to be downloaded. The position information of the current video to be downloaded in the video sequence to be downloaded can be characterized by the sequence number of the current video to be downloaded in the video sequence to be downloaded, that is, the position of the current video to be downloaded in the video sequence to be downloaded. The bit rate corresponding to each video to be downloaded refers to the download bit rate of the video to be downloaded. The buffer length information corresponding to each video to be downloaded may refer to the video length information that the video to be downloaded has downloaded and buffered. The buffer length information can be characterized by the buffer length or the buffer data volume corresponding to the video to be downloaded. The buffer data volume refers to the product of the buffer duration of the video to be downloaded and the download bit rate. It should be noted that if a certain video to be downloaded has not been downloaded at present, it is determined that the buffer length information corresponding to the video to be downloaded is 0.

Specifically, when it is determined that a certain video in the video sequence to be downloaded needs to be downloaded (the video is regarded as the current video to be downloaded), the current playing state information before downloading the current video to be downloaded can be obtained, so as to determine the appropriate download length information of the current video to be downloaded based on the current playing state information. For example, the playing duration and bandwidth are predicted based on the current playing information and/or the historical playing information to obtain the currently-predicted playing duration and the currently-predicted bandwidth, and the position information of the current video to be downloaded in the video sequence to be downloaded and the bit rate and buffer length information corresponding to each video to be downloaded in the video sequence to be downloaded.

S120: determining target download length information corresponding to the current video to be downloaded according to the current playing state information and a target prediction model; where the target prediction model is obtained by reinforcement learning based on a heuristic determining method and sample playing state information corresponding to a sample video to be downloaded, and the heuristic determining method is a method for determining length information that needs to be downloaded for the sample video to be downloaded by using a heuristic method.

Reinforcement learning is to learn an optimal behavior strategy through the interaction between an agent and the environment, so as to maximize the cumulative reward. Through reinforcement learning, it can be known what actions should be taken in what states to maximize the obtained reward. The reinforcement learning method can include model-free reinforcement learning and model-based reinforcement learning. The model-free reinforcement learning is to learn strategies directly from experience, and select the optimal actions by estimating the value function of state actions, such as a Q-learning method. The model-based reinforcement learning is to predict the future state and reward through the dynamic model of the learning environment, so as to make a plan, such as Monte Carlo tree search and dynamic planning. The action performed in reinforcement learning refers to the download length information, and the obtained environment state refers to the playing state information. The action space and the state space can be continuous or discrete. If the action space and the state space are continuous, a model-based reinforcement learning algorithm can be used. If the action space and the state space are discrete, a model-free reinforcement learning algorithm can be used. The executed download length information can be characterized by the download duration or the download data volume. For example, the action space in reinforcement learning can be characterized by the discrete download duration. For example, the action space is {0 s, 1 s, 2 s, 3 s, . . . , 14 s, 15 s}, where 0s indicates downloading no video. The state space may include the predicted playing duration, the predicted bandwidth, the position information of the video to be downloaded in the video sequence to be downloaded, the bit rate and buffer length information corresponding to each video to be downloaded in the video sequence to be downloaded, and all possible values of these features.

The heuristic determining method can be a method for determining download length information, which is determined in advance based on experience and group performance. The heuristic determining method can determine the download length information through any one of the configured heuristic formulas. The accuracy of the download length information determined by the heuristic determining method is within the acceptable range to have good robustness, but lacks the consumption of environmental feedback and cannot dynamically optimize the download length information determining strategy. The sample video to be downloaded refers to the video to be downloaded as a training sample. For example, the video downloaded by the client historically can be used as the sample video to be downloaded before being downloaded historically. The sample playing state information is used to characterize the information about the environment state where the client is located before downloading the sample video to be downloaded. For example, similar to the current playing state information, the sample playing state information may further include, but not limited to, at least one selected from the group consisting of the sample predicted playing duration, the sample predicted bandwidth, the position information of the sample video to be downloaded in the video sequence to be downloaded, and the bit rate and buffer length information corresponding to each video to be downloaded in the video sequence to be downloaded.

The target prediction model is a module obtained by reinforcement learning and used to predict the appropriate download length information of the video. For example, in the model-free reinforcement learning method, the target prediction model can refer to the state action value function (that is, Q function) after learning is completed. In the model-based reinforcement learning method, the target prediction model can refer to the neural network model used to determine the download length information. The target download length information refers to the appropriate download length information of the current video to be downloaded, such as the appropriate download duration or download data volume of the current video to be downloaded.

Specifically, reinforcement learning is performed based on the sample playing state information corresponding to the sample video to be downloaded. The download length information determined by reinforcement learning is obtained. Heuristic processing is performed based on the heuristic determining method and the sample playing state information corresponding to the sample video to be downloaded. The download length information determined by the heuristic method is obtained, and the download length information determined by the heuristic method is used to optimize the download length information determined by reinforcement learning, thereby improving the accuracy of determining the download length information and further improving the reinforcement learning effect. In the reinforcement learning process, the reinforcement learning method is combined with the heuristic determining method for joint decision-making, which can ensure the robustness of the determination result of download length information, thus improving the accuracy of the final determination result, and then obtaining a target prediction model that can accurately determine the download length information. The current playing state information is input into the target prediction model after reinforcement learning is completed to predict the information, and the target download length information corresponding to the current video to be downloaded output by the target prediction model is obtained, thus improving the accuracy of determining the download length information.

For example, reinforcement learning can refer to online reinforcement learning in the client, so that the client can consume the feedback of its interaction with the environment in real time, thereby optimizing its own download length information determining strategy, achieving the dynamic optimization of the strategy, and further improving the accuracy of determining the download length information. Moreover, online reinforcement learning is performed in the client, which can avoid the problem of data protection resulted from data acquisition.

S130: downloading the current video to be downloaded according to the target download length information corresponding to the current video to be downloaded.

Specifically, a download request corresponding to the current video to be downloaded is generated according to the target download length information, and the video is downloaded based on the download request, so that the current video to be downloaded with an appropriate length or an appropriate data volume can be downloaded, thereby improving the video playing fluency and reducing the bandwidth cost.

According to the technical solution of the embodiment of the present disclosure, reinforcement learning is performed based on the heuristic determining method and the sample playing state information corresponding to the sample video to be downloaded, so that in the reinforcement learning process, the heuristic determining method can be used to optimize the download length information determined by reinforcement learning. The reinforcement learning effect is improved, so that the target prediction model after reinforcement learning is completed can accurately determine the appropriate target download length information according to the current playing state information of the current video to be downloaded before downloading, and download the current video to be downloaded according to the target download length information, thus improving the accuracy of determining the download length information, and further improving the video playing fluency and reducing the bandwidth cost.

On the basis of the above technical solution, Step S130 may include randomly adjusting the target download length information based on a preset random variable to obtain a target download length information after adjustment; limiting a range of the target download length information after adjustment base on the preset download length information range to obtain the target download length information after limitation; and downloading the current video to be downloaded according to the target download length information after limitation.

The preset random variable can be a random variable that obeys normal distribution. The preset download length information range is a value range determined by the minimum download length information and the maximum download length information. The minimum download length information may refer to 0, that is, no video is downloaded. The maximum download length information may refer to the maximum length allowed for a single downloaded, such as the total length of the current video to be downloaded.

Specifically, the target download length information and the preset random variable are added to obtain the target download length information after randomly adjusting. By randomly adjusting the target download length information, the optimal download length information can be further explored, and then the accuracy of determining the download length information is improved. Based on the preset download length information range, the edges of the maximum value and the minimum value of the target download length information after adjustment are limited, so that the target download length information after limitation can better meet the actual download situation and further improve the rationality and accuracy of downloading videos.

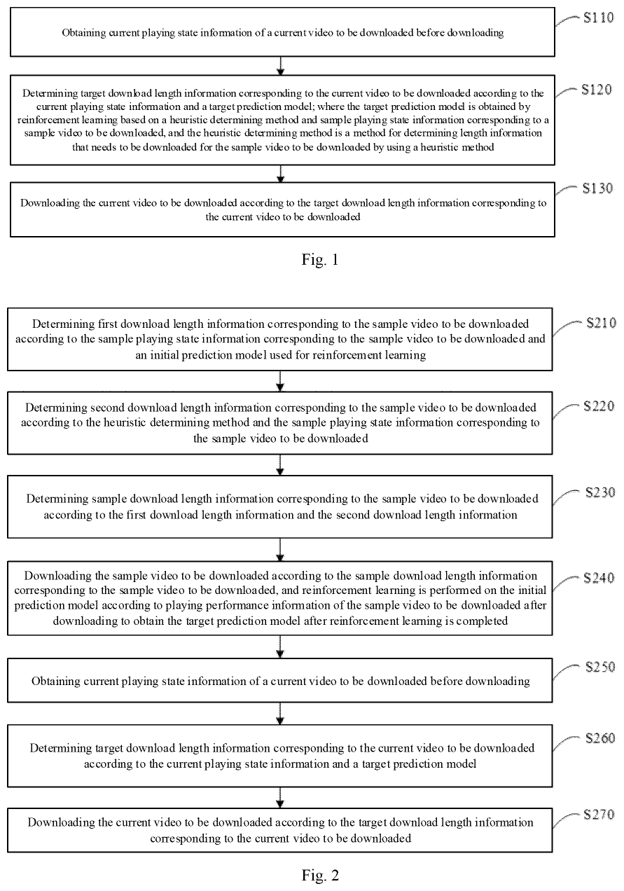

FIG. 2 is a flowchart of another video downloading method according to an embodiment of the present disclosure. The embodiment of the present disclosure describes the reinforcement learning process of the target prediction model in detail on the basis of the above embodiment of the present disclosure. The same or corresponding terms as the above embodiment of the present disclosures is not described in detail here.

As shown in FIG. 2, the video downloading method specifically includes the following steps.

S210: determining first download length information corresponding to the sample video to be downloaded according to the sample playing state information corresponding to the sample video to be downloaded and an initial prediction model used for reinforcement learning.

The initial prediction model refers to the prediction model that needs reinforcement learning, that is, the module used to predict the appropriate download length information of the video in reinforcement learning. For example, the initial prediction model can refer to the state action value function (that is, Q function) that needs to be learned or the neural network model that needs to be trained to determine the download length information. Before reinforcement learning, the initial prediction model can be initialized to obtain the initial prediction model when learning for the first time. The first download length information is the length information that needs to be downloaded for the sample video to be downloaded and that is determined by reinforcement learning. For example, the first download length information may include the first download duration or the first download data volume corresponding to the sample video to be downloaded. The first download data volume is the product of the first download duration and the download bit rate corresponding to the sample video to be downloaded.

Specifically, in each learning process of reinforcement learning, the sample playing state information corresponding to the sample video to be downloaded is input into the initial prediction model for information prediction, and the first download length information corresponding to the sample video to be downloaded output by the initial prediction model is obtained. For example, based on the state action value function, the initial prediction model determines the action with the highest value of the sample video to be downloaded under the sample playing state information as the first download length information. Alternatively, the neural network model makes an action decision based on the input sample playing state information, and obtains the optimal action output by the neural network model as the first download length information.

S220: determining second download length information corresponding to the sample video to be downloaded according to the heuristic determining method and the sample playing state information corresponding to the sample video to be downloaded.

The second download length information refers to the length information that needs to be downloaded for the sample video to be downloaded and that is determined by reinforcement learning. For example, the second download length information may include the second download duration or the second download data volume corresponding to the sample video to be downloaded. The second download data volume is the product of the second download duration and the download bit rate corresponding to the sample video to be downloaded.

Specifically, in each learning process of reinforcement learning, the accuracy of the first download length information determined by reinforcement learning is not good because reinforcement learning is not completed yet. At this time, heuristic determination is made according to the heuristic determining method and the sample playing state information to obtain the second download length information determined by the heuristic determining method. When reinforcement learning is not completed yet, the reinforcement learning method is combined with the heuristic determining method for joint decision-making, which can ensure the robustness of the determination of the final download length information, thus improving the accuracy of the final download length information.

For example, Step S220 may include: determining a target playing duration corresponding to the sample video to be downloaded according to the sample predicted playing duration corresponding to the sample video to be downloaded, a sample predicted bandwidth corresponding to the sample video to be downloaded, and a bit rate corresponding to the sample video to be downloaded; and determining the second download length information corresponding to the sample video to be downloaded according to the target playing duration and the buffer length information corresponding to the sample video to be downloaded.

Specifically, the playing weight is determined according to the sample prediction bandwidth and the bit rate corresponding to the sample video to be downloaded. For example, the sample prediction bandwidth is divided by the bit rate corresponding to the sample video to be downloaded, and the difference of the division result is subtracted from 1 as the playing weight. The sample predicted playing duration corresponding to the video to be downloaded is multiplied with the playing weight to obtain the target playing duration. The buffer duration corresponding to the sample video to be downloaded is subtracted from the target playing duration, and the obtained result is taken as the second download duration corresponding to the sample video to be downloaded. If the second download length information is the second download data volume, the second download length is multiplied by the bit rate corresponding to the sample video to be downloaded to obtain the second download data volume corresponding to the sample video to be downloaded. The second download length information with high robustness can be quickly determined by the heuristic determining method.

S230: determining sample download length information corresponding to the sample video to be downloaded according to the first download length information and the second download length information.

Specifically, the first download length information and the second download length information can be weighted and summed based on a fixed weight value or a dynamically changing weight value to obtain the appropriate sample download length information of the sample video to be downloaded. For example, with the increase of the number of reinforcement learning iterations, the weight value of the determination result of reinforcement learning gradually increases, so that with the continuous learning and optimization of reinforcement learning, the determination result of reinforcement learning can be used more, and then the experience learned before can be brought into play. When the reinforcement learning process is not completed, the determination result of reinforcement learning is integrated with the heuristic determination result, reinforcement learning can learn experience from the heuristic determining method, thus improving the accuracy of determining the final download length information.

For example, Step S230 may include: determining a first weight value corresponding to the first download length information according to the current number of reinforcement learning iterations and the preset number of learning iterations, and determining a second weight value corresponding to the second download length information according to the first weight value; and determining the sample download length information corresponding to the sample video to be downloaded according to the first weight value, the second weight value, the first download length information and the second download length information.

The current number of reinforcement learning iterations refers to the total number of times the initial prediction model has been updated at the current time. The reinforcement learning parameter in each pair of initial prediction models is updated once, and the current number of reinforcement learning iterations is increased by 1. The current number of reinforcement learning iterations can be used to characterize the current learning level of reinforcement learning. The preset number of learning iterations can be preset, and reinforcement learning can converge to the threshold of learning iterations with a better effect. The first weight value refers to the weight value of the first download length information determined by the reinforcement learning method. The second weight value refers to the second download length information weight value determined by the heuristic determining method.

Specifically, the current number of reinforcement learning iterations are divided by the preset number of learning iterations to obtain a first weight value corresponding to the first download length information. The first weight value is subtracted from 1 to obtain a second weight value corresponding to the second download length information. With the increasing number of reinforcement learning iterations, the first weight value corresponding to reinforcement learning can be gradually increased, so that experience can be continuously learned from the heuristic determining method in the stage that reinforcement learning is not completed. Moreover, with the continuous in-depth exploration of the initial prediction model through reinforcement learning, the first download length information determined by reinforcement learning can be used more, and the experience learned in the previous exploration can be brought into play, thereby continuously improving the accuracy of the first download length information. According to the first weight value and the second weight value, the first download length information and the second download length information are weighted and summed, and the obtained summation result is taken as the sample download length information corresponding to the sample video to be downloaded.

S240: downloading the sample video to be downloaded according to the sample download length information corresponding to the sample video to be downloaded, and reinforcement learning is performed on the initial prediction model according to playing performance information of the sample video to be downloaded after downloading to obtain the target prediction model after reinforcement learning is completed.

The playing performance information of the sample video to be downloaded after downloading can be used to characterize the influence of the sample video to be downloaded on the video playing performance after downloading. For example, the playing performance information may include issues such as whether video playing is stalling or not. The play performance information is the data fed back by the environment after the action is executed. By using the playing performance information, the advantages and disadvantages of the final sample download length information can be fed back.

Specifically, a download request corresponding to the sample video to be downloaded is generated according to the sample download length information, and the video is downloaded based on the download request, so that the sample video to be downloaded with an appropriate length or an appropriate data volume can be downloaded, thereby improving the video playing fluency and reducing the bandwidth cost. After the video sample to be downloaded is downloaded, that is, after the action is executed, the playing performance information after the action is executed can be obtained, and based on the playing performance information, reinforcement learning is performed on the initial prediction model until the reinforcement learning process is completed, and the initial prediction model after reinforcement learning is completed is taken as the target prediction model. Steps S210-S240 form a learning process of reinforcement learning. Repeated execution of Steps S210-S240 can achieve multiple learning of reinforcement learning until the reinforcement learning process is completed.

For example, “downloading the sample video to be downloaded according to the sample download length information corresponding to the sample video to be downloaded” in Step S240 may include:
randomly adjusting the sample download length information based on a preset random variable to obtain the sample download length information after adjustment; limiting a range of the sample download length information after adjustment based on a preset download length information range to obtain the sample download length information after limitation; and downloading the sample video to be downloaded according to the sample download length information after limitation.

The preset random variable can be a random variable that obeys normal distribution. The preset download length information range is a value range determined by the minimum download length information and the maximum download length information. The minimum download length information may refer to 0, that is, no video is downloaded. The maximum download length information may refer to the maximum length allowed for a single downloaded, such as the total length of the current video to be downloaded.

Specifically, the target download length information and the preset random variable are added to obtain the randomly target download length information after adjustment. By randomly adjusting the target download length information, the optimal download length information can be further explored, and then the accuracy of determining the download length information is improved. Based on the preset download length information range, the edges of the maximum value and the minimum value of the target download length information after adjustment are limited, so that the target download length information after limitation can better meet the actual download situation and further improve the rationality and accuracy of downloading videos.

For example, “reinforcement learning is performed on the initial prediction model according to playing performance information of the sample video to be downloaded after downloading to obtain the target prediction model after reinforcement learning is completed” in Step S240 may include: updating a reinforcement learning parameter in the initial prediction model and updating the current number of reinforcement learning iterations according to the playing performance information of the sample video to be downloaded after downloading; and in response to the playing performance information meeting a preset playing fluency condition, the current number of reinforcement learning iterations after update being greater than or equal to a preset number of learning iterations, and the reinforcement learning parameter in the initial prediction model meeting a preset convergence condition, determining that a reinforcement learning process of the initial prediction model is completed, and taking the initial prediction model after reinforcement learning process is completed as the target prediction model.

The preset playing fluency condition is the condition that is preset and that video fluency playing meets. For example, the preset playing fluency condition indicates that the playing performance information does not have playing stalling information.

Specifically, the current reward value is determined according to the downloaded playing performance information and the sample download length information, and the state action value function or the neural network weight in the initial prediction model is updated based on the current reward value, so as to further optimize the action selection strategy of reinforcement learning. The playing performance information may include whether stalling occurs within a preset time (such as 5 s) after downloading. If stalling occurs and the sample download length information is longer, the current reward value is smaller, so that the determination result of reinforcement learning can improve the video playing fluency and reduce the bandwidth cost. At the same time, the current number of reinforcement learning iterations is added to 1, so as to update the number of reinforcement learning iterations in real time with the increase of the number of updating times of the reinforcement learning parameter in the initial prediction model.

By detecting whether the downloaded playing performance information meets the preset playing fluency condition, it can be determined whether playing stalling occurs after a video is download based on the sample download length information, and then it can be determined whether the sample download length information is the appropriate download length information. By detecting whether the current number of reinforcement learning iterations after update is greater than or equal to the preset number of learning iterations, it can be determined whether reinforcement learning is likely to converge. For example, when the playing performance information meets the preset playing fluency condition, and the current number of reinforcement learning iterations after update is greater than or equal to the preset number of learning iterations, it indicates that the determined sample download length information is the appropriate download length information without affecting the playing performance, and reinforcement learning is likely to converge at present. At this time, it is possible to continue to detect whether the current reinforcement learning parameter in the initial prediction model meets the preset convergence condition, and then determine whether the reinforcement learning process is completed. For example, when it is detected that the current reinforcement learning parameter in the initial prediction model meets the preset convergence condition, it indicates that the accuracy of the download length information determined by the initial prediction model has met the requirement. At this time, it is unneeded to continue reinforcement learning, that is, it is determined that the reinforcement learning process of the initial prediction model is completed, and the initial prediction model after reinforcement learning process is completed is used as the target prediction model, thus completing the whole reinforcement learning process. For example, if the state action value function in the initial prediction model tends to be unchanged, or the reward value tends to be unchanged, it can be determined that the current reinforcement learning parameter in the initial prediction model meets the preset convergence condition.

For example, Step S240 may further include: in response to the playing performance information meeting the preset playing fluency condition, the current number of reinforcement learning iterations after update being greater than or equal to the preset number of learning iterations, and the reinforcement learning parameter in the initial prediction model not meeting a preset convergence condition, determining that the reinforcement learning process of the initial prediction model is not completed, and adjusting the current number of reinforcement learning iterations after update to continue performing reinforcement learning on the initial prediction model, until the playing performance information meets the preset playing fluency condition, the current number of reinforcement learning iterations after update is greater than or equal to the preset number of learning iterations, and the reinforcement learning parameter in the initial prediction model meets the preset convergence condition.

Specifically, if the playing performance information meets the preset playing fluency condition, and the current number of reinforcement learning iterations after update is greater than or equal to the preset number of learning iterations, when it is detected that the current reinforcement learning parameter in the initial prediction models does not meet the preset convergence condition, such as when the state action value function in the initial prediction model changes greatly or the reward value changes greatly, it indicates that the accuracy of the download length information determined by the initial prediction model has not met the requirement. At this time, it is needed to continue reinforcement learning, that is, it is determined that the reinforcement learning process of the initial prediction model is not completed yet, and the current number of reinforcement learning iterations after update need to be adjusted so that the adjusted current number of reinforcement learning iterations is less than the preset number of learning iterations, thus avoiding frequently detecting whether the reinforcement learning parameter in the initial prediction model meets the preset convergence condition, and further reducing the performance overhead. For example, the current number of reinforcement learning iterations after update can be multiplied with the preset weight for adjustment, where the preset weight is a weight value less than 1, so that the adjusted current number of reinforcement learning iterations is less than the preset number of learning iterations. It should be noted that the current number of reinforcement learning iterations is adjusted, so that the first weight value corresponding to the first download length information determined by the reinforcement learning method can be reduced synchronously, thereby improving the second weight value corresponding to the second download length information determined by the heuristic method, and further improving the accuracy of determining the download length information. Based on the adjusted current number of reinforcement learning iterations, reinforcement learning continues to be performed on the initial prediction model. For example, the above Steps S210-S240 are repeatedly executed for subsequent learning, until the playing performance information meets the preset playing fluency condition, the current number of reinforcement learning iterations after update is greater than or equal to the preset number of learning iterations, and the reinforcement learning parameter in the initial prediction model meets the preset convergence condition, and it is determined that the reinforcement learning process of the initial prediction model is completed.

For example, Step S240 may further include: in response to the playing performance information meeting the preset playing fluency condition, and the current number of reinforcement learning iterations after update being less than the preset number of learning iterations, determining that the reinforcement learning process of the initial prediction model is not completed to continue performing reinforcement learning on the initial prediction model, until the playing performance information meets the preset playing fluency condition, the current number of reinforcement learning iterations after update is greater than or equal to the preset number of learning iterations, and the reinforcement learning parameter in the initial prediction model meets the preset convergence condition.

Specifically, when the playing performance information meets the preset playing fluency condition, and the current number of reinforcement learning iterations after update is less than the preset number of learning iterations, it indicates that the currently determined sample download length information is the appropriate download length information without affecting the playing performance, but the current reinforcement learning cannot achieve convergence. Therefore, it can be determined that the reinforcement learning process is not completed yet, and it is needed to continue the reinforcement learning of the initial prediction model. For example, the above Steps S210-S240 are repeatedly executed for subsequent learning, until the playing performance information meets the preset playing fluency condition, the current number of reinforcement learning iterations after update is greater than or equal to the preset number of learning iterations, and the reinforcement learning parameter in the initial prediction model meets the preset convergence condition, and it is determined that the reinforcement learning process of the initial prediction model is completed. It should be noted that the periodic detection of convergence can be achieved by setting the preset number of learning iterations, and the performance overhead resulted from frequent detection of convergence can be avoided.

For example, Step S240 may further include: in response to the playing performance information not meeting the preset playing fluency condition, determining that the reinforcement learning process of the initial prediction model is not completed, and adjusting the current number of reinforcement learning iterations after update to continue performing reinforcement learning on the initial prediction model, until the playing performance information meets the preset playing fluency condition, the current number of reinforcement learning iterations after update is greater than or equal to the preset number of learning iterations, and the reinforcement learning parameter in the initial prediction model meets the preset convergence condition.

Specifically, when the playing performance information does not meet the preset playing fluency condition, it indicates that the currently determined sample download length information is not the appropriate download length information, which affects the playing performance. At this time, it is needed to continue reinforcement learning, that is, it is determined that the reinforcement learning process of the initial prediction model is not completed yet. At the same time, regardless of whether the current number of reinforcement learning iterations after update is less than or greater than or equal to the preset number of learning iterations, it is needed to punish the current number of reinforcement learning iterations after update to some extent, so as to perform learning optimization on reinforcement learning for more times and further improve the reinforcement learning effect. For example, the current number of reinforcement learning iterations after update is multiplied with the preset weight for adjustment, where the preset weight is a weight value less than 1, so that the adjusted current number of reinforcement learning iterations is less than the original current number of reinforcement learning iterations. Based on the adjusted current number of reinforcement learning iterations, reinforcement learning continues to be performed on the initial prediction model. For example, the above Steps S210-S240 are repeatedly executed for subsequent learning, until the playing performance information meets the preset playing fluency condition, the current number of reinforcement learning iterations after update is greater than or equal to the preset number of learning iterations, and the reinforcement learning parameter in the initial prediction model meets the preset convergence condition, and it is determined that the reinforcement learning process of the initial prediction model is completed.

S250: obtaining current playing state information of a current video to be downloaded before downloading.

S260: determining target download length information corresponding to the current video to be downloaded according to the current playing state information and a target prediction model.

S270: downloading the current video to be downloaded according to the target download length information corresponding to the current video to be downloaded.

According to the technical solution of the embodiment of the present disclosure, first download length information corresponding to the sample video to be downloaded is determined according to the sample playing state information corresponding to the sample video to be downloaded and an initial prediction model used for reinforcement learning. Second download length information corresponding to the sample video to be downloaded is determined according to the heuristic determining method and the sample playing state information. The final sample download length information is determined based on the first download length information and the second download length information. The sample video to be downloaded is downloaded according to the sample download length information, and reinforcement learning is performed on the initial prediction model according to downloaded playing performance information to obtain the target prediction model after reinforcement learning is completed. In this way, in the reinforcement learning process, the heuristic determining method is used to optimize the reinforcement learning method, thus determining the appropriate download length information more accurately, improving the robustness and accuracy of determining the download length information, and further improving the video playing fluency and reducing the bandwidth cost.

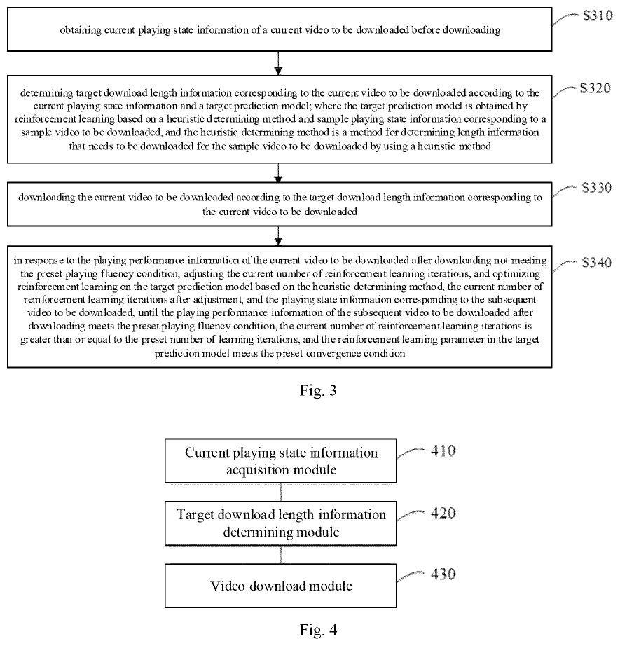

FIG. 3 is a flowchart of still another video downloading method according to an embodiment of the present disclosure. The embodiment of the present disclosure describes the continuous optimization process of the target prediction model in detail after downloading the current video to be downloaded on the basis of the above embodiment of the present disclosure. The same or corresponding terms as the above embodiment of the present disclosures is not described in detail here.

As shown in FIG. 3, the video downloading method specifically includes the following steps:
S310: obtaining current playing state information of a current video to be downloaded before downloading;
S320: determining target download length information corresponding to the current video to be downloaded according to the current playing state information and a target prediction model; where the target prediction model is obtained by reinforcement learning based on a heuristic determining method and sample playing state information corresponding to a sample video to be downloaded, and the heuristic determining method is a method for determining length information that needs to be downloaded for the sample video to be downloaded by using a heuristic method;
S330: downloading the current video to be downloaded according to the target download length information corresponding to the current video to be downloaded; and
S340: in response to the playing performance information of the current video to be downloaded after downloading not meeting the preset playing fluency condition, adjusting the current number of reinforcement learning iterations, and optimizing reinforcement learning on the target prediction model based on the heuristic determining method, the current number of reinforcement learning iterations after adjustment, and the playing state information corresponding to the subsequent video to be downloaded, until the playing performance information of the subsequent video to be downloaded after downloading meets the preset playing fluency condition, the current number of reinforcement learning iterations is greater than or equal to the preset number of learning iterations, and the reinforcement learning parameter in the target prediction model meets the preset convergence condition.

Specifically, after the reinforcement learning process is completed, it indicates that the result determined by reinforcement learning is better. At this time, the target prediction model can be directly used to determine the appropriate target download length information without combining the heuristic determining method, thus ensuring the accuracy of determining the target prediction model and saving the performance overhead of the heuristic determination. In this way, the target prediction model obtained by reinforcement learning can determine the download length information fully based on the learned experience and reduce the dependence on the heuristic determining method.

When the reinforcement learning process is completed, although it is not needed to combine the heuristic determining method, it can be continuously determined whether the reinforcement learning parameter in the target prediction model needs to be updated and optimized according to the playing performance information of the current video to be downloaded after downloading, so as to achieve continuous online reinforcement learning and further ensure the accuracy of determining the download length information by using the target prediction model.

Specifically, by detecting whether the downloaded playing performance information meets the preset playing fluency condition, it is determined whether the video download based on the target download length information leads to playing stalling, so as to determine whether the target download length information is the appropriate download length information, and further determine whether it is needed to continue to optimize reinforcement learning on the target prediction model. For example, when the playing performance information of the current video to be downloaded after downloading does not meet the preset playing fluency condition, it indicates that the trained reinforcement learning cannot accurately determine the appropriate download length information due to some unexpected factors. At this time, the reinforcement learning parameter in the target prediction model can be continuously optimized and learned. Specifically, the current number of reinforcement learning iterations can be set to zero, or adjusted based on the preset weight, so as to appropriately reduce the current number of reinforcement learning iterations. Therefore, the subsequent result tends to be the heuristic determination result, so that the target prediction model can learn more from the heuristic determining method. According to the reinforcement learning process described in the above Steps S210-S240, the reinforcement learning parameter in the target prediction model is further optimized based on the heuristic determining method, the current number of reinforcement learning iterations after adjustment and the playing state information corresponding to the subsequent video to be downloaded, so that the optimized target prediction model can more accurately determine the appropriate download length information, and the accuracy and robustness of the determination result are further improved.

It should be noted that when the playing performance information of the current video to be downloaded after downloading meets the preset playing fluency condition, it indicates that the current reinforcement learning effect is very good, and the target prediction model can accurately determine the appropriate download length information. At this time, there is no need to optimize the target prediction model, so that the appropriate download length information can be determined only by the target prediction model without considering the heuristic determining method, thus saving the performance overhead.

According to the technical solution of the embodiment of the present disclosure, when the playing performance information of the current video to be downloaded after downloading does not meet the preset playing fluency condition, reinforcement learning is continuously optimized on the target prediction model based on the heuristic determining method, the current number of reinforcement learning iterations after adjustment and the playing state information corresponding to the subsequent video to be downloaded, so that the target prediction model is optimized dynamically, the optimized target prediction model determines the appropriate download length information more accurately, and the accuracy and robustness of the determination result are further improved.

FIG. 4 is a schematic structural diagram of a video downloading apparatus according to an embodiment of the present disclosure. As shown in FIG. 4, the apparatus specifically includes a current playing state information acquisition module 410, a target download length information determining module 420 and a video download module 430.

The current playing state information acquisition module 410 is configured to obtain current playing state information of a current video to be downloaded before downloading; the target download length information determining module 420 is configured to determine target download length information corresponding to the current video to be downloaded according to the current playing state information and a target prediction model; where the target prediction model is obtained by reinforcement learning based on a heuristic determining method and sample playing state information corresponding to a sample video to be downloaded, and the heuristic determining method is to determine length information that needs to be downloaded for the sample video to be downloaded based on a present heuristic processing method; and the video download module 430 is configured to download the current video to be downloaded according to the target download length information corresponding to the current video to be downloaded.

According to the technical solution of the embodiment of the present disclosure, reinforcement learning is performed based on the heuristic determining method and the sample playing state information corresponding to the sample video to be downloaded, so that in the reinforcement learning process, the heuristic determining method can be used to optimize the download length information determined by reinforcement learning. The reinforcement learning effect is improved, so that the target prediction model after reinforcement learning is completed can accurately determine the appropriate target download length information according to the current playing state information of the current video to be downloaded before downloading, and download the current video to be downloaded according to the target download length information, thus improving the accuracy of determining the download length information, and further improving the video playing fluency and reducing the bandwidth cost.

On the basis of the above technical solution, the current playing state information includes at least one selected from the group consisting of:
a currently-predicted playing duration, a currently-predicted bandwidth, position information of the current video to be downloaded in a video sequence to be downloaded, and a bit rate and buffer length information corresponding to each video to be downloaded in the video sequence to be downloaded.

On the basis of the above technical solution, the apparatus further includes:
a first download length information determining module, which is configured to determine first download length information corresponding to the sample video to be downloaded according to the sample playing state information corresponding to the sample video to be downloaded and an initial prediction model used for reinforcement learning;
a second download length information determining module, which is configured to determine second download length information corresponding to the sample video to be downloaded according to the heuristic determining method and the sample playing state information corresponding to the sample video to be downloaded;
a sample download length information determining module, which is configured to determine sample download length information corresponding to the sample video to be downloaded according to the first download length information and the second download length information; and
a reinforcement learning module, which is configured to download the sample video to be downloaded according to the sample download length information corresponding to the sample video to be downloaded, and perform reinforcement learning on the initial prediction model according to playing performance information of the sample video to be downloaded after downloading to obtain the target prediction model after reinforcement learning is completed.

On the basis of the above technical solution, the second download length information determining module is specifically configured to:
determine a target playing duration corresponding to the sample video to be downloaded according to a sample predicted playing duration corresponding to the sample video to be downloaded, a sample predicted bandwidth corresponding to the sample video to be downloaded, and a bit rate corresponding to the sample video to be downloaded; and determine the second download length information corresponding to the sample video to be downloaded according to the target playing duration and the buffer length information corresponding to the sample video to be downloaded.

On the basis of the above technical solution, the sample download length information determining module is specifically configured to:
determine a first weight value corresponding to the first download length information according to the current number of reinforcement learning iterations and the preset number of learning iterations, and determine a second weight value corresponding to the second download length information according to the first weight value; and determine the sample download length information corresponding to the sample video to be downloaded according to the first weight value, the second weight value, the first download length information and the second download length information.

On the basis of the above technical solution, the reinforcement learning module is specifically configured to:
update a reinforcement learning parameter in the initial prediction model and update the current number of reinforcement learning iterations according to the playing performance information of the sample video to be downloaded after downloading; and
in response to that the playing performance information meeting a preset playing fluency condition, the current number of reinforcement learning iterations after update being greater than or equal to the preset number of learning iterations, and the reinforcement learning parameter in the initial prediction model meeting a preset convergence condition, determine that a reinforcement learning process of the initial prediction model is completed, and take the initial prediction model after reinforcement learning process is completed as the target prediction model.

On the basis of the above technical solution, the reinforcement learning module is specifically configured to:
in response to the playing performance information meeting the preset playing fluency condition, the current number of reinforcement learning iterations after update being greater than or equal to the preset number of learning iterations, and the reinforcement learning parameter in the initial prediction model not meeting a preset convergence condition, determine that the reinforcement learning process of the initial prediction model is not completed, and adjust the current number of reinforcement learning iterations after update to continue performing reinforcement learning on the initial prediction model, until the playing performance information meets the preset playing fluency condition, the current number of reinforcement learning iterations after update is greater than or equal to the preset number of learning iterations, and the reinforcement learning parameter in the initial prediction model meets the preset convergence condition;
in response to the playing performance information meeting the preset playing fluency condition, and the current number of reinforcement learning iterations after update being less than the preset number of learning iterations, determine that the reinforcement learning process of the initial prediction model is not completed to continue performing reinforcement learning on the initial prediction model, until the playing performance information meets the preset playing fluency condition, the current number of reinforcement learning iterations after update is greater than or equal to the preset number of learning iterations, and the reinforcement learning parameter in the initial prediction model meets the preset convergence condition; and
in response to the playing performance information not meeting the preset playing fluency condition, determine that the reinforcement learning process of the initial prediction model is not completed, and adjust the current number of reinforcement learning iterations after update to continue performing reinforcement learning on the initial prediction model, until the playing performance information meets the preset playing fluency condition, the current number of reinforcement learning iterations after update is greater than or equal to the preset number of learning iterations, and the reinforcement learning parameter in the initial prediction model meets the preset convergence condition.

On the basis of the above technical solution, the reinforcement learning module is specifically configured to:
randomly adjust the sample download length information based on a preset random variable to obtain the sample download length information after adjustment; limit the range of the sample download length information after adjustment base on a preset download length information range to obtain the sample download length information after limitation; and download the sample video to be downloaded according to the sample download length information after limitation.

On the basis of the above technical solution, the apparatus further includes:
a target prediction model optimization module, which is configured to, after downloading the current video to be downloaded, in response to the playing performance information of the current video to be downloaded after downloading not meeting the preset playing fluency condition, adjust the current number of reinforcement learning iterations, and optimize reinforcement learning on the target prediction model based on the heuristic determining method, the current number of reinforcement learning iterations after adjustment, and the playing state information corresponding to the subsequent video to be downloaded, until the playing performance information of the subsequent video to be downloaded after downloading meets the preset playing fluency condition, the current number of reinforcement learning iterations is greater than or equal to the preset number of learning iterations, and the reinforcement learning parameter in the target prediction model meets the preset convergence condition.

The video downloading apparatus according to the embodiment of the present disclosure can execute the video downloading method according to any embodiment of the present disclosure, and has corresponding functional modules and beneficial effects of the executed method.

It is worth noting that each of the units and modules included in the above apparatus is only divided according to functional logic, which is not limited to the above division, as long as the corresponding functions can be achieved. In addition, the specific name of each functional unit is only for the convenience of distinguishing each other, and is not used to limit the scope of protection of the embodiment of the present disclosure.

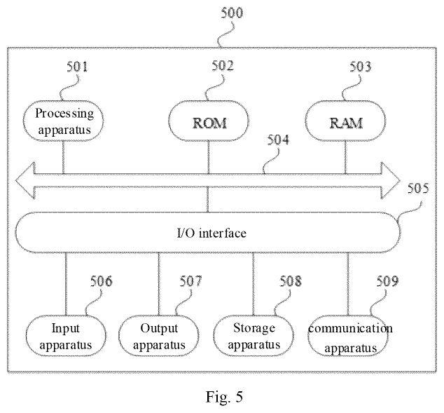

FIG. 5 is a schematic structural diagram of an electronic device according to an embodiment of the present disclosure. Reference is now made to FIG. 5, which shows a structural schematic diagram of an electronic device (e.g., a terminal device or a server in FIG. 5) 500 suitable for implementing an embodiment of the present disclosure. The terminal device in the embodiment of the present disclosure may include, but are not limited to, a mobile terminal such as a mobile phone, a notebook computer, a digital broadcast receivers, a PDA (Personal Digital Assistant), a PAD (Tablet Computer), a PMP (Portable Multimedia Player), a vehicle-mounted terminal (such as vehicle-mounted navigation terminals), and a fixed terminal such as a digital TV and a desktop computer. The electronic device shown in FIG. 5 is only an example, and should not bring any limitation to the function and application scope of the embodiment of the present disclosure.

As shown in FIG. 5, an electronic device 500 may include a processing apparatus (such as a central processing unit, a graphics processor, etc.) 501, which may perform various appropriate actions and processes according to a program stored in a read-only memory (ROM) 502 or a program loaded from a storage apparatus 508 into a random access memory (RAM) 503. In the RAM 503, various programs and data required for the operation of the electronic device 500 are also stored. A processing apparatus 501, a ROM 502 and a RAM 503 are connected to each other through a bus 504. An editing/output (I/O) interface 505 is also connected to the bus 504.

Generally, the following devices can be connected to the I/O interface 505: an input apparatus 506 including, for example, a touch screen, a touchpad, a keyboard, a mouse, a camera, a microphone, an accelerometer, a gyroscope, etc.; An output apparatus 507 including, for example, a liquid crystal display (LCD), a speaker, a vibrator, etc. Includes a storage apparatus 508 such as a magnetic tape, a hard disk, etc. And a communication apparatus 509. The communication apparatus 509 may allow the electronic device 500 to communicate wirelessly or wired with other devices to exchange data. Although FIG. 5 shows an electronic device 500 with various devices, it should be understood that it is not required to implement or have all the devices shown. More or fewer devices may alternatively be implemented or provided.

In particular, according to an embodiment of the present disclosure, the process described above with reference to the flowchart can be implemented as a computer software program. For example, embodiments of the present disclosure include a computer program product including a computer program carried on a non-transitory computer-readable medium, which contains program code for executing the method shown in the flowchart. In such an embodiment, the computer program can be downloaded and installed from the network through the communication apparatus 509, or installed from the storage apparatus 508 or from the ROM 502. When the computer program is executed by the processing apparatus 501, the above functions defined in the method of the embodiment of the present disclosure are performed.

The names of messages or information exchanged among a plurality of devices in the embodiment of the present disclosure are only used for illustrative purposes, and are not used to limit the scope of these messages or information.

The electronic device provided by the embodiment of this disclosure belongs to the same inventive concept as the video downloading method provided by the above embodiment, and the technical details not described in detail in this embodiment can be found in the above embodiment, and this embodiment has the same beneficial effects as the above embodiment.

An embodiment of the present disclosure provides a computer storage medium on which a computer program is stored, which, when executed by a processor, realizes the video downloading method provided in the above embodiment.

It should be noted that the computer-readable medium mentioned above in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or device, or a combination of any of the above. More specific examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage apparatus, a magnetic storage apparatus, or any suitable combination of the above. In this disclosure, a computer-readable storage medium can be any tangible medium containing or storing a program, which can be used by or in combination with an instruction execution system, apparatus or device. In this disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program code contained in the computer-readable medium can be transmitted by any suitable medium, including but not limited to: wires, optical cables, RF (radio frequency) and the like, or any suitable combination of the above.

In some embodiments, clients and servers can communicate with any currently known or future developed network protocol, such as HTTP(HyperText Transfer Protocol), and can be interconnected with digital data communication in any form or medium (for example, communication network). Examples of communication networks include a local area network (“LAN”), a wide area network (“WAN”), the Internet (for example, the Internet) and end-to-end networks (for example, ad hoc end-to-end networks), as well as any currently known or future developed networks.

The computer-readable medium may be included in the electronic device. Or, it can exist alone without being assembled into the electronic equipment.

The computer-readable medium carries one or more programs, which, when executed by the electronic device, cause the electronic device to: acquire the current playing state information of the video to be downloaded before downloading; Determining target download length information corresponding to the current video to be downloaded according to the current playing state information and the target prediction model; Wherein, the target prediction model is obtained by reinforcement learning based on a heuristic determination method and sample playback state information corresponding to the sample video to be downloaded, wherein the heuristic determination method is a method for determining the length information of the sample video to be downloaded by heuristic method; Downloading the current video to be downloaded according to the target download length information corresponding to the current video to be downloaded.

Computer program codes for performing the operations of the present disclosure may be written in one or more programming languages or their combinations, including but not limited to object-oriented programming languages such as Java, Smalltalk, C++, as well as conventional procedural programming languages such as “C” or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

Embodiments of the present invention also provide a computer program product, including a computer program, which, when executed by a processor, realizes the video downloading method provided in the above embodiments.

In the process of implementation of computer program products, computer program codes for performing the operations of the present invention can be written in one or more programming languages or their combinations, including object-oriented programming languages, such as Java, Smalltalk, C++, and conventional procedural programming languages, such as “C” or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units described in the embodiments of the present disclosure can be realized by software or hardware. Among them, the name of the unit does not constitute the limitation of the unit itself in some cases. For example, the first acquisition unit can also be described as “the unit that acquires at least two Internet protocol addresses”.

The functions described above herein may be performed, at least in part, by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of this disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage apparatus, a magnetic storage apparatus, or any suitable combination of the above.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. A video downloading method, comprising:
obtaining current playing state information of a current video to be downloaded before downloading;
determining download length information corresponding to the current video to be downloaded according to the current playing state information and a prediction model; wherein the prediction model is obtained by reinforcement learning based on a heuristic determining method and sample playing state information corresponding to a sample video to be downloaded, and the heuristic determining method is a method for determining length information that needs to be downloaded for the sample video to be downloaded by using a heuristic method; and
downloading the current video to be downloaded according to the download length information corresponding to the current video to be downloaded.

2. The video downloading method according to claim 1, wherein the current playing state information comprises at least one selected from the group consisting of a currently-predicted playing duration, a currently-predicted bandwidth, position information of the current video to be downloaded in a video sequence to be downloaded, and a bit rate and buffer length information corresponding to each video to be downloaded in the video sequence to be downloaded.

3. The video downloading method according to claim 1, wherein the prediction model being obtained by reinforcement learning based on the heuristic determining method and the sample playing state information corresponding to a sample video to be downloaded comprises:
determining first download length information corresponding to the sample video to be downloaded according to the sample playing state information corresponding to the sample video to be downloaded and an initial prediction model used for reinforcement learning;
determining second download length information corresponding to the sample video to be downloaded according to the heuristic determining method and the sample playing state information corresponding to the sample video to be downloaded;
determining sample download length information corresponding to the sample video to be downloaded according to the first download length information and the second download length information; and
downloading the sample video to be downloaded according to the sample download length information corresponding to the sample video to be downloaded, and performing reinforcement learning on the initial prediction model according to playing performance information of the sample video to be downloaded after downloading to obtain the prediction model after reinforcement learning is completed.

4. The video downloading method according to claim 3, wherein determining the second download length information corresponding to the sample video to be downloaded according to the heuristic determining method and the sample playing state information corresponding to the sample video to be downloaded comprises:
determining a playing duration corresponding to the sample video to be downloaded according to a sample predicted playing duration corresponding to the sample video to be downloaded, a sample predicted bandwidth corresponding to the sample video to be downloaded, and a bit rate corresponding to the sample video to be downloaded; and
determining the second download length information corresponding to the sample video to be downloaded according to the playing duration and the buffer length information corresponding to the sample video to be downloaded.

5. The video downloading method according to claim 3, wherein determining sample download length information corresponding to the sample video to be downloaded according to the first download length information and the second download length information comprises:
determining a first weight value corresponding to the first download length information according to a current number of reinforcement learning iterations and a preset number of learning iterations, and determining a second weight value corresponding to the second download length information according to the first weight value; and
determining the sample download length information corresponding to the sample video to be downloaded according to the first weight value, the second weight value, the first download length information and the second download length information.

6. The video downloading method according to claim 3, wherein performing reinforcement learning on the initial prediction model according to the playing performance information of the sample video to be downloaded after downloading to obtain the prediction model after reinforcement learning is completed comprises:
updating a reinforcement learning parameter in the initial prediction model and updating a current number of reinforcement learning iterations according to the playing performance information of the sample video to be downloaded after downloading; and
in response to the playing performance information meeting a preset playing fluency condition, the current number of reinforcement learning iterations after updating being greater than or equal to a preset number of learning iterations, and the reinforcement learning parameter in the initial prediction model meeting a preset convergence condition, determining that a reinforcement learning process of the initial prediction model is completed, and taking the initial prediction model after the reinforcement learning process is completed as the prediction model.

7. The video downloading method according to claim 6, further comprising:
in response to the playing performance information meeting the preset playing fluency condition, the current number of reinforcement learning iterations after update being greater than or equal to the preset number of learning iterations, and the reinforcement learning parameter in the initial prediction model not meeting the preset convergence condition, determining that the reinforcement learning process of the initial prediction model is not completed, and adjusting the current number of reinforcement learning iterations after update to continue performing reinforcement learning on the initial prediction model, until the playing performance information meets the preset playing fluency condition, the current number of reinforcement learning iterations after update is greater than or equal to the preset number of learning iterations, and the reinforcement learning parameter in the initial prediction model meets the preset convergence condition;
in response to the playing performance information meeting the preset playing fluency condition, and the current number of reinforcement learning iterations after update is less than the preset number of learning iterations, determining that the reinforcement learning process of the initial prediction model is not completed to continue performing reinforcement learning on the initial prediction model, until the playing performance information meets the preset playing fluency condition, the current number of reinforcement learning iterations after update is greater than or equal to the preset number of learning iterations, and the reinforcement learning parameter in the initial prediction model meets the preset convergence condition; and
in response to the playing performance information not meeting the preset playing fluency condition, determining that the reinforcement learning process of the initial prediction model is not completed, and adjusting the current number of reinforcement learning iterations after update to continue performing reinforcement learning on the initial prediction model, until the playing performance information meets the preset playing fluency condition, the current number of reinforcement learning iterations after update is greater than or equal to the preset number of learning iterations, and the reinforcement learning parameter in the initial prediction model meets the preset convergence condition.

8. The video downloading method according to claim 3, wherein downloading the sample video to be downloaded according to the sample download length information corresponding to the sample video to be downloaded comprises:
randomly adjusting the sample download length information based on a preset random variable to obtain the sample download length information after adjustment;
limiting a range of the sample download length information after adjustment based on a preset download length information range to obtain the sample download length information after limitation; and
downloading the sample video to be downloaded according to the sample download length information after limitation.

9. The video downloading method according to claim 1, wherein after downloading the current video to be downloaded, the method further comprises:
in response to playing performance information of the current video to be downloaded after downloading not meeting a preset playing fluency condition, adjusting a current number of reinforcement learning iterations, and optimizing reinforcement learning on the prediction model based on the heuristic determining method, the current number of reinforcement learning iterations after adjustment, and the playing state information corresponding to a subsequent video to be downloaded, until the playing performance information of the subsequent video to be downloaded after downloading meets the preset playing fluency condition, the current number of reinforcement learning iterations is greater than or equal to a preset number of learning iterations, and a reinforcement learning parameter in the prediction model meets a preset convergence condition.

10. An electronic device, wherein the electronic device comprises:
one or more processors; and
a storage apparatus, configured to store one or more programs,
wherein the one or more programs, when executed by the one or more processors, cause the one or more processors to implement a video downloading method, and the method comprises:
obtaining current playing state information of a current video to be downloaded before downloading;
determining download length information corresponding to the current video to be downloaded according to the current playing state information and a prediction model; wherein the prediction model is obtained by reinforcement learning based on a heuristic determining method and sample playing state information corresponding to a sample video to be downloaded, and the heuristic determining method is a method for determining length information that needs to be downloaded for the sample video to be downloaded by using a heuristic method; and
downloading the current video to be downloaded according to the download length information corresponding to the current video to be downloaded.

11. The electronic device according to claim 10, wherein the current playing state information comprises at least one selected from the group consisting of a currently-predicted playing duration, a currently-predicted bandwidth, position information of the current video to be downloaded in a video sequence to be downloaded, and a bit rate and buffer length information corresponding to each video to be downloaded in the video sequence to be downloaded.

12. The electronic device according to claim 10, wherein the prediction model being obtained by reinforcement learning based on the heuristic determining method and the sample playing state information corresponding to the sample video to be downloaded, comprises:
determining first download length information corresponding to the sample video to be downloaded according to the sample playing state information corresponding to the sample video to be downloaded and an initial prediction model used for reinforcement learning;
determining second download length information corresponding to the sample video to be downloaded according to the heuristic determining method and the sample playing state information corresponding to the sample video to be downloaded;
determining sample download length information corresponding to the sample video to be downloaded according to the first download length information and the second download length information; and
downloading the sample video to be downloaded according to the sample download length information corresponding to the sample video to be downloaded, and performing reinforcement learning on the initial prediction model according to playing performance information of the sample video to be downloaded after downloading to obtain the prediction model after reinforcement learning is completed.

13. The electronic device according to claim 12, wherein determining the second download length information corresponding to the sample video to be downloaded according to the heuristic determining method and the sample playing state information corresponding to the sample video to be downloaded comprises:
determining a playing duration corresponding to the sample video to be downloaded according to a sample predicted playing duration corresponding to the sample video to be downloaded, a sample predicted bandwidth corresponding to the sample video to be downloaded, and a bit rate corresponding to the sample video to be downloaded; and
determining the second download length information corresponding to the sample video to be downloaded according to the playing duration and buffer length information corresponding to the sample video to be downloaded.

14. The electronic device according to claim 12, wherein determining the sample download length information corresponding to the sample video to be downloaded according to the first download length information and the second download length information comprises:
determining a first weight value corresponding to the first download length information according to a current number of reinforcement learning iterations and a preset number of learning iterations, and determining a second weight value corresponding to the second download length information according to the first weight value; and
determining the sample download length information corresponding to the sample video to be downloaded according to the first weight value, the second weight value, the first download length information and the second download length information.

15. The electronic device according to claim 12, wherein performing reinforcement learning on the initial prediction model according to the playing performance information of the sample video to be downloaded after downloading to obtain the prediction model after reinforcement learning is completed comprises:
updating a reinforcement learning parameter in the initial prediction model and updating a current number of reinforcement learning iterations according to the playing performance information of the sample video to be downloaded after downloading; and
in response to the playing performance information meeting a preset playing fluency condition, the current number of reinforcement learning iterations after update being greater than or equal to a preset number of learning iterations, and the reinforcement learning parameter in the initial prediction model meeting a preset convergence condition, determining that a reinforcement learning process of the initial prediction model is completed, and taking the initial prediction model after the reinforcement learning process is completed as the prediction model.

16. A non-transitory storage medium containing computer-executable instructions, wherein the computer-executable instructions, when executed by a computer processor, are configured to execute the video downloading method, and the method comprises:
obtaining current playing state information of a current video to be downloaded before downloading;
determining download length information corresponding to the current video to be downloaded according to the current playing state information and a prediction model; wherein the prediction model is obtained by reinforcement learning based on a heuristic determining method and sample playing state information corresponding to a sample video to be downloaded, and the heuristic determining method is a method for determining length information that needs to be downloaded for the sample video to be downloaded by using a heuristic method; and
downloading the current video to be downloaded according to the download length information corresponding to the current video to be downloaded.

17. The non-transitory storage medium according to claim 16, wherein the current playing state information comprises at least one selected from the group consisting of a currently-predicted playing duration, a currently-predicted bandwidth, position information of the current video to be downloaded in a video sequence to be downloaded, and a bit rate and buffer length information corresponding to each video to be downloaded in the video sequence to be downloaded.

18. The non-transitory storage medium according to claim 16, wherein the prediction model being obtained by reinforcement learning based on the heuristic determining method and the sample playing state information corresponding to the sample video to be downloaded, comprises:
determining first download length information corresponding to the sample video to be downloaded according to the sample playing state information corresponding to the sample video to be downloaded and an initial prediction model used for reinforcement learning;
determining second download length information corresponding to the sample video to be downloaded according to the heuristic determining method and the sample playing state information corresponding to the sample video to be downloaded;
determining sample download length information corresponding to the sample video to be downloaded according to the first download length information and the second download length information; and
downloading the sample video to be downloaded according to the sample download length information corresponding to the sample video to be downloaded, and performing reinforcement learning on the initial prediction model according to playing performance information of the sample video to be downloaded after downloading to obtain the prediction model after reinforcement learning is completed.

19. The non-transitory storage medium according to claim 18, wherein determining the second download length information corresponding to the sample video to be downloaded according to the heuristic determining method and the sample playing state information corresponding to the sample video to be downloaded comprises:
determining a playing duration corresponding to the sample video to be downloaded according to a sample predicted playing duration corresponding to the sample video to be downloaded, a sample predicted bandwidth corresponding to the sample video to be downloaded, and a bit rate corresponding to the sample video to be downloaded; and
determining the second download length information corresponding to the sample video to be downloaded according to the playing duration and buffer length information corresponding to the sample video to be downloaded.

20. The non-transitory storage medium according to claim 18, wherein determining the sample download length information corresponding to the sample video to be downloaded according to the first download length information and the second download length information comprises:
determining a first weight value corresponding to the first download length information according to a current number of reinforcement learning iterations and a preset number of learning iterations, and determining a second weight value corresponding to the second download length information according to the first weight value; and
determining the sample download length information corresponding to the sample video to be downloaded according to the first weight value, the second weight value, the first download length information and the second download length information.
